(19) United States
(12) Patent Application Publication
(10) Pub. No.: US 2011/0246379 A1
(43) Pub. Date: Oct. 6, 2011

(54) INTELLECTUAL PROPERTY SCORING PLATFORM

(75) Inventors: Jeff Maddox, Baltimore, MD (US); Jason David Resnick, Clifton, VA (US); Randy W. Lacasse, Fairfax Station, VA (US)

(73) Assignee: CPA GLOBAL PATENT RESEARCH LIMITED, St. Helier (JE)

(21) Appl. No.: 12/753,326

(22) Filed: Apr. 2, 2010

(51) Int. Cl. G06Q 99/00; G06Q 10/00; G06F 3/048

(52) U.S. Cl. 705/310; 715/764

(57) ABSTRACT

A method, system, and apparatus for scoring an intellectual property asset, such as a patent. A platform for automated scoring can implement a z-score statistical method, or variations thereof, to score a patent. The z-score statistical method can be used to measure where a value of a parameter in a patent lies in relation to the average value of that parameter in a patent population. Parameter scores can be obtained for each parameter of the patent. Additionally, a composite score can be provided that indicates an overall score or value of the patent, at least with respect to the parameters examined, as against the patent population. The composite score can be a weighted score of the z-scores of different parameters of the patent.

### FIELD OF THE DISCLOSURE

This generally relates to techniques for scoring intellectual property assets, such as a patent.

### BACKGROUND

Intellectual property assets, such as patents, are vital to certain segments of the economy and contribute to the success of many businesses worldwide. Intellectual property assets may be used in a variety of contexts and for a variety of purposes. A patent portfolio may help a business to protect its investments, revenues and assets. For example, a strong patent portfolio may create barriers to entry for competitors and preserve an exclusive market space for products and services offered by a business. A patent portfolio may be valuable to a business because it generates revenue through patent licensing or assignments. It may be a powerful bargaining tool for obtaining access to other patented technologies, e.g., by cross-licensing. A patent portfolio may also serve as a defensive tool when facing a patent infringement suit. For example, a company with a broad and strong patent portfolio may counter-sue for infringement of its own patents and force the suing party into settlement quickly.

Because of the abstract nature of an intellectual property asset, however, it can be difficult to make decisions regarding how to manage or assert the intellectual property asset. Patents have varying quality and value. A large number of patents of varying quality and value get filed every year in various technological fields in different countries across the world. Some of these patents protect a company's core technologies, while others protect non-core technologies or merely small incremental improvements from well-known technologies. Furthermore, the cost of developing, maintaining, or acquiring a patent portfolio may be substantial. Therefore, a business should evaluate the value of its patent portfolio on a regular basis, and devise a patent portfolio strategy that is aligned with the company's business objectives.

For example, maintenance fees must be paid intermittently to maintain a patent in force. Because maintenance fees can be expensive, many patents lapse due to failure to pay a maintenance fee. For this reason, a company may decide to abandon or sell its non-core patents which are of low value to the business. Conversely, a company may decide to maintain or renew a core, high-value patent or even file additional members within the same patent family. A patent owner with an impending maintenance fee due date may be interested in determining a score or relative value of his patent to aid in deciding whether to pay the maintenance fee. A systematic and objective method of assessing a quality, or value, of a patent or portfolio using patent search engine and intellectual property data resources would be useful for these and other purposes.

### SUMMARY

Various embodiments are provided for an intellectual property assessment platform for scoring an intellectual property asset, such as a patent. A patent can be scored relative to a patent population. The patent population can be populated with patents selected in a number of ways. The particular patents in a patent population can reveal various characteristics of a patent of interest. A patent of interest can be compared to multiple patent populations to reveal different characteristics of the patent of interest.

The platform can implement a z-score statistical method, or variations thereof, to score a patent. The z-score statistical method can be used, for example, to measure where a value of a parameter in a patent lies in relation to the average value of that parameter in a patent population. The patent can be scored with respect to a number of parameters. Parameter scores can be obtained for each parameter of the patent. Additionally, a composite score can be provided that indicates an overall score or value of the patent, at least with respect to the parameters examined, relative to the patent population. The composite score can be a weighted score of the z-scores of different parameters of the patent.

The platform can be used to score a patent or patent portfolio. Parameter scores and a composite score can be determined for each patent in the portfolio. Various comparisons can be made and trends or characteristics can be identified based on parameter scores and composite scores of the portfolio's patents. The platform also can be used to score a patent with respect to a group of patents with a known value or certain known characteristics. For example, a patent or portfolio of patents can be compared with a group of patents that have been successful in litigation. In addition, the platform can be used to locate patents of similar subject matter, technicality, complexity, etc., and then score the patent with respect to such peer patents.

A user can use information obtained in scoring a patent or patent portfolio via the platform in making various decisions. Such decisions can include, for example, whether to pursue litigation, whether to license, whether to sell, and whether to pay a maintenance fee for a patent or a portfolio of patents.

### BRIEF DESCRIPTION OF THE DRAWINGS

FIG. 1 illustrates an example of a process for scoring a patent;

FIG. 2 illustrates an example of search platform architecture;

FIG. 3 illustrates an example of a process for searching a patent collection;

FIG. 4 illustrates an example of a graphical user interface of the exemplary scoring platform;

FIG. 5 illustrates a more detailed view of a graphical user interface of the scoring platform showing various scoring parameters; and

FIG. 6 illustrates an example of a computing device.

### DETAILED DESCRIPTION

In the following description of the invention, reference is made to the accompanying drawings which form a part hereof, and in which it is shown by way of illustration specific embodiments in which the invention may be practiced. It is to be understood that other embodiments may be utilized and structural changes may be made without departing from the scope of the preferred embodiments of the present invention.

The various preferred and alternative exemplary embodiments relate to an intellectual property assessment platform for scoring an intellectual property asset, such as a patent. A patent, which can be a patent of interest to a user, can be scored relative to a patent population. The patent population can be populated with patents selected in a number of ways. The selection of a patent population can reveal various implications of certain characteristics/parameters of the patent and various extrapolations can be made regarding a future value of the patent.

The platform can implement a z-score statistical method, or variations thereof, to score a patent. The z-score statistical method can be used, for example, to measure where a value of a parameter in a patent lies in relation to the average value of that parameter in a patent population. The patent can be scored with respect to a number of parameters. Parameter scores can be obtained for each parameter of the patent. Additionally, a composite score can be provided that indicates an overall score or value of the patent, at least with respect to the parameters examined, as against the patent population. The composite score can be a weighted score of the z-scores of different parameters of the patent.

The platform can be used to score a patent portfolio, such that parameter scores and a composite score are determined for each patent in the portfolio. Various comparisons can be made and trends or characteristics can be identified based on parameter scores and composite scores of the patents. The platform also can be used to score a patent with respect to a group of patents with a known value or certain known characteristics. For example, a patent or portfolio of patents can be compared with a group of patents that have been successful in litigation. In addition, the platform can be used to locate patents of similar subject matter, technicality, complexity, etc., and then score the patent with respect to such peer patents.

A user can use information obtained in scoring a patent or patent portfolio via the platform in making various decisions. Such decisions can include, for example, whether to pursue litigation, whether to license, whether to sell, and whether to pay a maintenance fee.

Although the exemplary embodiments are discussed with respect to scoring a patent, the platform described can be applied to any type of intellectual property asset, such as a patent application, a trademark, or a copyright.

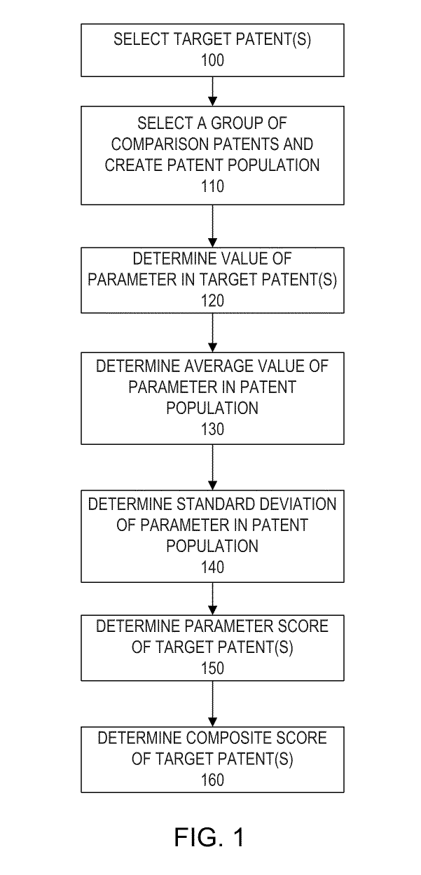

FIG. 1 illustrates an embodiment of an exemplary process for scoring a patent. One or more target patents can be selected (block 100). The target patent(s) can be a patent of interest to a user, such as a recently issued patent. The target patent(s) can be specified by the user via a user interface. For example, a user can provide identification information for the target patent(s), such as its patent number. A location of the target patent(s) also can be provided, such as in a work file or database. Alternatively, search terms can be provided to a search engine via the user interface to identify a target patent(s). However selected, a copy of the target patent(s) can be obtained for processing. In an embodiment, no target patent(s) is selected at the outset and the process steps can be performed with respect to all patents in a particular patent population.

A group of comparison patents can be selected and included in a patent population (block 110). Comparison patents are patents with which a user may compare to the target patent. In other words, the target patent(s) is scored relative to the comparison patents. The group of comparison patents can be selected in various ways, including any manner by which the target patent(s) is selected or identified, e.g., via specification of identification information of the comparison patents, via a work file, or via a search engine. Additionally, the group of patents can be automatically selected, as discussed further below. In some instances, the group of comparison patents can constitute a technology sphere, which is a group of patents that are closely related to the subject matter of the target patent(s).

However the group of comparison patents is identified, the patents in the group can be associated with each other as a patent population. The patent population could also include the target patent(s) and/or certain default or baseline patents. Whether to include the target patent(s) and/or default or baseline patents can depend on the parameter(s) to be evaluated and the characteristics of the identified group of patents and the target patent. For example, if the group of comparison patents consists of software patents that have been successful in previous litigations, as in the example above, it may not be helpful to include the target patent(s) as a member of the patent population if the target patent(s) has not been involved in any litigation. However, it could be helpful to include some kind of baseline software patent to provide a baseline or standard as against the rest of the population.

The techniques of selecting the target patent(s) and/or the group of comparison patents using a search engine or through specifying a work file will now be discussed in more detail.

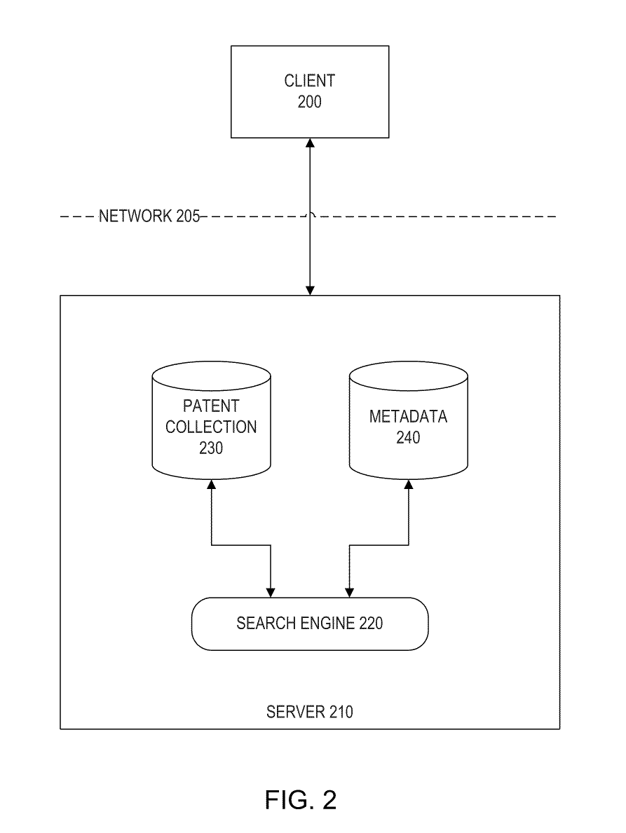

In an embodiment in which the target patent(s) and/or the group of comparison patents are identified using a search engine, a search can be performed on a patent collection. FIG. 2 illustrates an embodiment of exemplary search platform architecture. In the illustrated embodiment, client 200 can access server 210 across network 205. Client 200 can be a user operated computer, for example. Server 210 can deploy search engine 220, which can be associated with patent collection 230 and metadata 240.

Patent collection 230 can include one or more databases storing patent documents, such as patents and/or patent publications for example, associated with one or more national patent offices. Metadata 240 can include one or more databases storing data associated with the patent documents. The data can include bibliographic information, document vectors, classification information, summaries or abstracts, etc., related to the documents in the collection. The data can be organized in an index including a record for each document.

Although patent collection 230 and metadata 240 are shown as distinct databases in the embodiment illustrated in FIG. 2, in other embodiments the data embodied in patent collection 230 and metadata 240 can be stored together in one or more databases or other suitable storage medium.

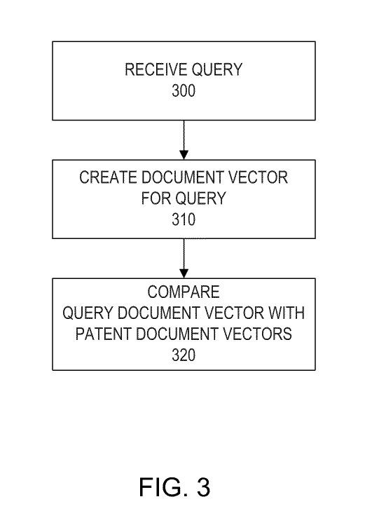

A search can be executed by search engine 220 over patent collection 230. The ways in which search engine 220 can search a document collection can be myriad. FIG. 3 illustrates an embodiment in which search engine 220 can employ a vector based search methodology. However, other search methodologies can be used, such as indexed-based keyword searching.

In using a vector based search methodology as illustrated in the embodiment of FIG. 3, upon receiving a query (block 300) search engine 220 can create (block 310) a document vector for the query. For example, the document vector can be a weighted list of words and phrases, such as:

[table, 1][chair, 0.5][plate, 0.2]

as a simplified example. Once the query document vector is created, search engine 220 can compare (block 320) the query document vector with document vectors retrieved from patent collection 230 that have been previously created for each of the patent documents in patent collection 230. The document vectors can also be stored in metadata 240, such as in a record in the index corresponding to each document in patent collection 230. The comparison can include, for example, multiplying the weights of any common terms among the query document vector and the retrieved document vector, and adding the results to obtain a similarity ranking. Taking another simplified example:

query document vector: [table, 1][chair, 0.5][plate, 0.2]

retrieved document vector: [cup, 1][saucer, 0.7][chair, 0.6][plate, 0.5]

similarity=0.5*0.6+0.2*0.5=0.4

If the similarity ranking exceeds a predefined threshold, search engine 220 can consider the patent document associated with the retrieved document vector to be a match.

The search can be performed based solely on a user's query as detailed above. The search also can be performed based on the selected target patent. In such a case, search engine 220 can retrieve a document vector corresponding to the target patent and can create a query document vector based on the contents of the retrieved document vector. This type of search can be considered a Find Similar search because patents similar to the target patent are found through comparison of the target patent's document vector to other document vectors of patents in the collection. Alternatively, search engine 220 can create a query document vector based both on a user's query and the target patent.

As an example, a user may own a patent related to electronic staplers, which the user could designate as the target patent. The user may wish to compare the patent with other electronic stapler patents. The user could thus search for patents with the keywords “electronic stapler.” All resulting patents could be selected as the group of comparison patents and included in the patent population. Alternatively, the user could select only particular ones of the resulting patents as comparison patents. For example, the user may desire to sell the patent to a manufacturer of electronic staplers. The user could thus select only the resulting patents that are assigned to the manufacturer. Another search method for identifying relevant patents to compare with the target patent could be to identify the class(es) with which the target patent is associated and search for other patents within the identified class(es).

In an embodiment, a user may be interested in determining whether a particular technical field is crowded, meaning that there are many patents covering most aspects of the technical field. The user could identify patents within the technical field through keyword searching or by identifying the class(es) associated with the technical field. The resulting patents could be designated as the target patents. Comparison patents may be patents within a particular technical field known to be crowded (or known not to be crowded).

In an embodiment, a user may be searching for a good law firm to perform patent prosecution work. The user may be interested in scoring patents handled by the law firm. The user could thus search for all patents associated with the particular law firm and designate the resulting patents as the target patents. The user could score these target patents relative to a group of comparison patents having known value.

As discussed previously, in an embodiment the target patents and/or group of comparison patents can be identified through the selection of a work file. The work file may contain copies of the patents or may only identify the patents through identification information, such as patent numbers. The work files can reside on a local computer system or on a remote system.

The work files can be user-provided or system-provided. A user-provided work file could consist of a particular patent portfolio or patents otherwise of interest to the user. The user could have created the work file or obtained it from another source. A system-provided work file could consist of one or more predetermined patent groups having known characteristics or value. An example of such a group could be software patents that have been successful in previous litigations. Thus, because the software patents in the group have known value (i.e., they were successfully asserted), they could provide insight into the target patent's potential value.

In an embodiment, system-provided work files can be specifically selected by a user. Alternatively, system-provided work files can be automatically selected by the system when a user selects a score category (or when the system selects a score category by default). A score category is a predefined category for scoring the selected target patent(s). Multiple score categories can be predetermined and stored by the system. A score category can be selected by default upon start-up of the system. Alternatively, a user can select a score category via the graphical user interface. Additionally, a user can create a score category and store it in the system, for example in association with a user profile. The user may also specify a particular score category as a default to be automatically selected whenever the user logs-in to the system.

There may be various score categories. For example, example score categories include: validity, breadth of claims, likelihood of success in litigation, and licensing potential. Each score category can be adapted specifically for particular technical fields. For example, there may be a validity score category for each of business method patents, biotechnology patents, and mechanical patents. Of course, these categories could be broken down further.

A score category can have associated with it a predefined group of comparison patents. The score category can also define a set of one or more parameters to be scored and predefined weights for preset parameters, as discussed below.

A value of one or more parameters in a target patent can be determined (block 120). The parameter(s) can be a characteristic or metric of the patent, such as the number of claims in a patent or the average number of words in the independent claims. A table of exemplary potential parameters that can be used for scoring patents is provided below.

Table of Exemplary Patent Scoring Parameters

| | |
|---|---|
| Legal Status | Number of Annuities paid |
| Number of Forward citations | Number of Citations cited by the |
| Number of Backward citations | examiner |
| Number of distinct countries of filing | Number of clauses in the First |
| within the family | Independent Claims |
| Age (in Years) | Number of co-pending patents |
| Number of Independent Claims | Number of Dependent Claims |
| Number of Words in the first Claim | Number of different words in the |
| Average age of backward citations | First Independent Claim |
| Number of International Patent | Number of Foreign backward |
| Classification (IPC) Codes | citations |
| Number of Current US classes | Number of Inventive Codes |
| Number of Inventors | Number of Non Patent Literature |
| Pendency period | Number of office action |
| | amendments |
| Average Relevancy Score of most | (i.e. Number of non-final |
| most relevant patents | rejections) |
| Average age of forward citations | Number of Reassignments |
| Recent Citations | Number of times independent |
| | claims have been |
| Number of drawings | amended by applicant |
| Number of forward citations by | Opposition |
| others (decisions regarding | Patent abandonment rate |
| licensing/sale) | Percent of Assignee's patents in |
| Number of forward citations by self | same class |
| (renewal decisions) | Quality of description |
| Total number of claims (dependant | Ratio of density of own portfolio in |
| and independent) | this technology to overall patents |
| Average Family Size of Assignee | in this technology |
| Breadth of Cited IPC's | Ratio of independent claims |
| | retained and independent |
| Breadth of Citing IPC's | claims filed |
| Breadth of Cited United States | Ratio of words before amendments |
| Patent Classifications (USPC's) | and after amendments |
| Breadth of Citing USPC's | Risk of conflict |
| Breadth of Inventive Codes | Royalty rates |
| Breadth of IPC's | Self vs. Other Citations |
| Breadth of USPCs | Trend of number of granted patents |
| Number of Statutory Classes | and applications for each year in |
| Current US Class | the last 10 years |
| Current IPC | Type of Reassignment |
| Certificate of correction granted | Enforceability |
| Density (Number of Patents and | Number of rejections received in |
| Applications in this US Class in | the filing process |
| the last 10 years) | Number of cases of infringement |
| Entity class | assertion action |
| European Patent (EP) Family | Number of related domestic patents |
| Member | Number of related foreign patents |
| Has a Request for Continuing | Number of Non-Inventive Codes |
| Examination (RCE) been filed? | Patent activity of first inventor |
| Is the patent a foreign filing? | Patent activity of major patent |
| Japanese Patent (JP) Family | holders in trailing 5 years |
| Member | Patent maintenance rate |
| Multiple cites to/from same assignee | Patent maintenance value |
| | Patent survival rate |
| | Present year - Earliest Priority year |
| | Priority Date |
| | Reexamination Requested: |
| | Relative earliness of priority date |
| | Total number of assignee |
| | Type of Claim |
| | Number of Pages in the Patent |

The parameter(s) can be automatically selected by the system, for example, if the user has selected a score category. Alternatively, a user can manually select the parameter(s) to be used in scoring the target patent(s). In an embodiment, all potential parameters can be displayed via a graphical user interface along with corresponding weights. For example, if a score category has been selected, the unselected/unweighted parameters can be displayed with each weight set to zero. If no score category has been selected, all parameters can be displayed with each weight set to zero. A user can select a parameter by modifying the corresponding weight to be more than zero.

In an embodiment, a user can create a custom parameter. For example, the user could specify the parameter as measuring the number of times a particular word appears in the claims of a patent. In an embodiment, this could be implemented by providing a keyword parameter via the graphical user interface along with a textbox for accepting a text input from the user to specify the keyword. Such a parameter could be easily measured, for example, by parsing each document and incrementing a counter each time the specified word is found.

In an embodiment, even if the user selects a score category having preset parameters and weights, the user can still modify the weights of the parameters to tweak the scoring as the user sees fit. For example, the user can even eliminate a preselected parameter by modifying its corresponding weight to be zero or can add additional parameters that were not preselected by modifying the additional parameters' weights to be greater than zero.

To determine the value of a parameter, a patent can be dynamically (e.g., on the fly) parsed and analyzed. Alternatively, such parsing and analyzing can be performed prior to performing this process and the values of the parameters can be stored, for example as metadata in association with the patent. As another approach, the parameters can be determined dynamically and then stored in association with the patent for future use in later analyses.

An average value of the parameter can be determined for the patent population (block 130). For populations containing only a predetermined group of comparison patents, the average value of the parameter may have been calculated beforehand and thus immediately available without further processing. In other cases, it may be necessary to determine the value of the parameter for each member of the population and then calculate the average of those values.

A standard deviation of the parameter can be determined for the patent population (block 140). The standard deviation may be known beforehand for populations containing only a predetermined group of comparison patents. The standard deviation also can be calculated using the following equation:

$$σ = \sqrt{\frac{1}{N} {\sum }_{i = 1}^{N} {( {x}_{i} - μ )}^{2}}$$

where σ is the standard deviation, N is the number of patents in the patent population, xᵢ is the value of the parameter for the i^{th} patent in the patent population, and μ is the average value of the parameter in the patent population.

A parameter score can be determined (block 150) for the parameter under examination for each of the target patents. For a particular target patent, the parameter score can be determined based on the target patent's value of the parameter, the patent population's average value of the parameter, and the patent population's standard deviation of the parameter. For example, the parameter score can be determined using a z-score algorithm, such as in the following equation:

$$z = \frac{x - μ}{σ}$$

where z is the z-score, x is the value of the parameter in the target patent, μ is the average value of the parameter in the patent population, and σ is the standard deviation of the parameter in the population.

For each target patent, a composite score can be determined (block 160) and provided as a measure of the value of the target patent. The composite score can be determined based on the target patent's parameter scores. In an embodiment using the z-score to calculate the parameter score, each parameter score can be converted to a percentile rank using a statistics table based on a normal distribution for converting z-scores to percentiles. The percentile rank of a score is the percentage of scores in its frequency distribution which are lower than it.

If only one parameter was considered, the percentile rank for the parameter score of that parameter can be provided as the composite score. In an embodiment, the z-score or the percentile rank can be altered to account for, for example, a margin of error. Such an altered score, altered rank, or rank based on an altered score, can be provided as the composite score.

If multiple parameters have been considered, the composite score can reflect all of the multiple parameters. For example, the composite score can be a weighted average of all of the parameter scores based on the weights assigned to each parameter. The weights can be predetermined or can be specified by the user, as discussed previously. In an embodiment, the weights are provided as percentages and add up to 100%. Alternatively, the weights can be normalized to equal 100%.

If the weights are predetermined, a default may be to assign each parameter equal weight. For specific predetermined combinations of parameters corresponding to score categories, such as for a likelihood of validity valuation, the parameters may be weighted according to the relative importance of each parameter in determining the value of the patent in that context. In a likelihood of validity valuation, for example, a number of cited references listed in the patent may be indicative of the quality of examination of the patent application from which the patent issued, and thus its likelihood of validity. Therefore, such a parameter could be given a higher weight. A number of listed inventors, on the other hand, may not be as indicative of the likelihood of validity of the patent, and thus such a parameter could be given a lower weight.

Determining the composite score with multiple parameters can involve multiplying each parameter by its respective weight and adding the results together to obtain a weighted total parameter score. A percentile can be determined from the weighted total parameter score based on a statistics table, as discussed previously. Alternatively, the percentile of each parameter score could be determined and then the percentiles could be appropriately weighted and added together.

In an embodiment, a parameter score (or scores when multiple parameters are involved) and a composite score can be determined for each patent in the patent population. Having such statistics for all patents in the population (plus the target patent if applicable) can be useful for many reasons. In some instances, the patent population includes patents that make up a user's patent portfolio, as discussed below, and so the scores for each patent are important for assessing the strength of the portfolio. In other instances, even though the target patent may be the only patent of interest to the user, it can be helpful to see parameter scores for patents in the patent population in order to compare individual parameter scores of the target patent with the parameter scores of the patents in the population. In addition, the patent population may include patents owned by competitors, and thus it can be useful to see the competitors' patents' overall strengths and weaknesses (via the composite score) and particular strengths and weaknesses (via the parameter scores).

A user may wish to score his or her patent portfolio. The user can specify each patent as a target patent as well as a comparison patent, thus scoring each member of the portfolio against all of the patents in the portfolio. In this way, the user can see how each patent fares against the others and can determine the portfolio's most valuable patents. In some cases, the user may add additional comparison patents which are not in the portfolio. Alternatively, the user can score each patent in the portfolio individually against each patent's own peer patents found through a Find Similar search. A composite score of the portfolio can be determined based on each patent's individual composite score. If a patent portfolio contains multiple family counterpart patents, such as foreign counterparts of a domestic patent, the counterparts can be eliminated to avoid skewing the composite score of the portfolio.

The parameter scores and composite scores of the target patents and/or the patents in the patent population can be displayed via the graphical user interface, as discussed below. In an embodiment, parameter scores can be determined and displayed via the graphical user interface even for parameters whose corresponding weights are set to zero. Thus, a user may still see the parameter score of a zero-weighted parameter and can decide whether to adjust the corresponding weight based on any correlations that may be revealed by the parameter score. For instance, the user may determine that a previously zero-weighted parameter is actually a good indication of some characteristic that the user wants reflected in the final composite score(s) of the target patent(s). In addition, the system can be configured to automatically recalculate and display the composite score(s) of the target patent(s) substantially as the user adjusts the corresponding weight of a parameter, taking into account normal latency in computation and data travel.

In an embodiment, the graphical user interface can provide additional analysis capabilities for the returned data. For example, a patent of the target patents or population patents can be selected and information regarding the patent can be depicted visually via the graphical user interface. The target patents, the population patents, or both, could also be graphed with respect to each other to depict their various scores relative to each other. Alternatively, the patents with their corresponding scores could be organized in a report that the user could print out or save. The report could contain graphs depicting the results of the scoring.

In an embodiment, the composite scores of the target patent(s) can be compared to the parameter scores of the target patent(s) to determine whether a correlation exists. If a positive correlation exists between a parameter score and the composite score, the weight corresponding to the parameter can be increased. In this way, the parameter-weight grouping can be fine-tuned to provide a more accurate score. This correlation process could be performed with respect to population patents as well to fine-tune a score category, for example.

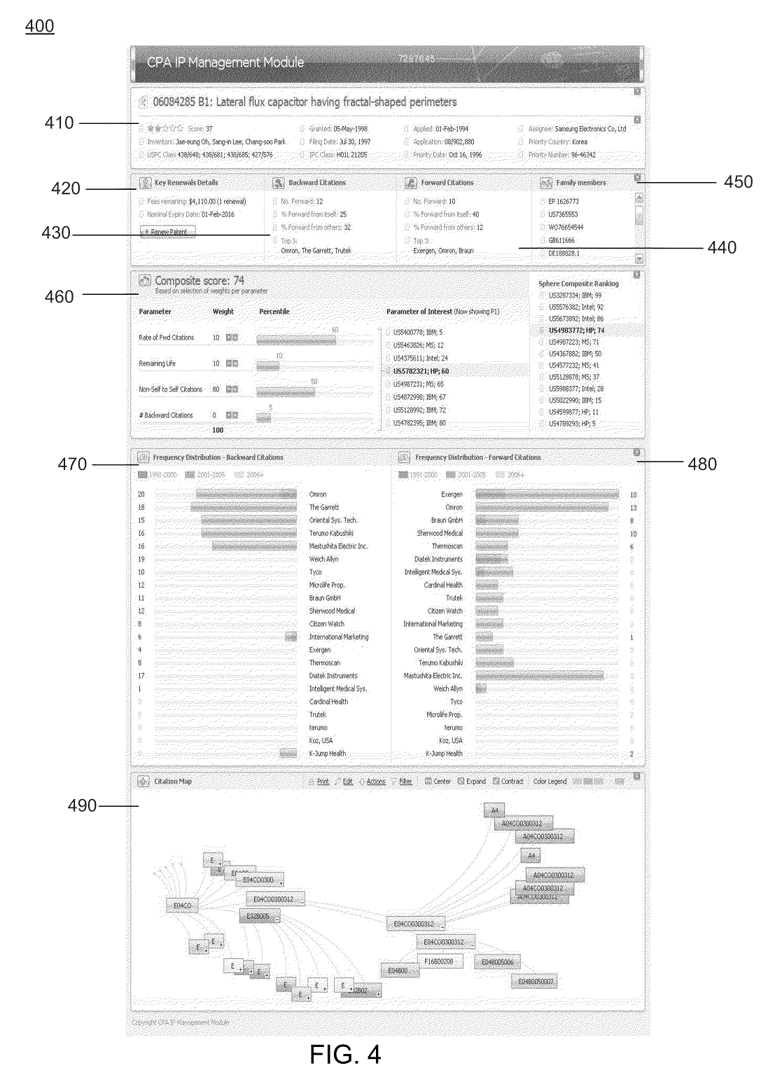

FIG. 4 illustrates an exemplary embodiment of a graphical user interface 400 that can be displayed to a user. In this example, scores for multiple parameters have been determined for all patents in a population (including a target patent). Please note that the data in this figure does not actually apply to the displayed patent and is only provided for illustration of exemplary features of the interface.

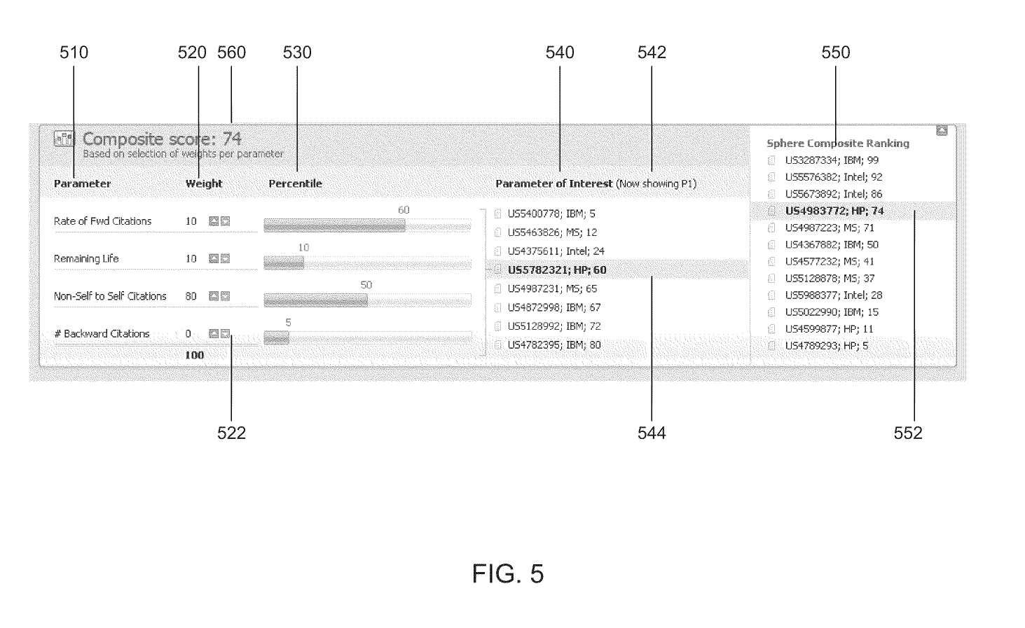

Section 410 of the graphical user interface can provide bibliographic information regarding a selected patent. The selected patent can be the target patent or it can be a patent selected from the patent population. Section 420 can provide renewal information regarding the selected patent. Of course, if the selected patent is not a patent owed by the user, the section 420 would not give an option to renew the patent. Sections 430, 440, and 450 can provide backward citation information, forward citation information, and family member information, respectively, associated with the selected patent. Section 460 is a score section that can provide scoring information, as discussed in detail with respect to FIG. 5. Sections 470 and 480 can provide frequency distribution information regarding backward citations and forward citations, respectively, associated with the selected patent. The frequency distribution information indicates the number of citations to references associated with particular assignees as well as the number of such citations in particular year ranges. Section 490 provides a citation map illustrating the interrelationships between citations.

Sections 430, 440, 450, 470, and 480 relate to selected parameters. A user can select other parameters for display in these sections. Accordingly, the scoring platform provides a user with much more than parameter scores and composite scores of selected patents. A user is able to view specific information regarding each parameter as it relates to a selected patent vis-à-vis the patent population.

FIG. 5 illustrates a more detailed view of the score section 460 of graphical user interface 400. Various parameters can be listed in a parameter section 510. The four listed parameters could have been specified by a user or automatically selected by the system. In an embodiment, all potential parameters can be listed in parameter section 510. In such a case, a button could be provided for scrolling through parameter section 510 to see all listed parameters.

A weight to be assigned to each parameter can be displayed in a weight section 520. The weights can be adjusted via buttons 522. In this example, three parameters have been assigned weights above zero, all adding up to the value one hundred. In an embodiment, the interface could require that all weights add up to the value one hundred in order to ensure calculation of an appropriate composite score.

The parameter score can be displayed as a percentile in percentile section 530. The z-score for each parameter can be converted into a percentile using a statistics table, as discussed previously. Even though the fourth parameter (# Backward Citations) has a zero weight, the percentile can still be displayed.

The target patent and each patent in the patent population can be listed in parameter of interest section 540. Each entry in the list can provide the patent number of a patent in the patent population, the patent's assignee, and the patent's parameter score for the parameter of interest. A button can be provided for scrolling through parameter of interest section 540 if the number of patents is greater than can fit on the screen at the same time.

Status indicator 542 indicates that parameter scores for the first parameter (Rate of Fwd Citations) are currently shown. The highlighted entry 544 is the patent for which information is currently shown in the percentile section 530. If a different patent is highlighted, the parameter scores of that patent can be shown in the percentile section 530. Also, if a different parameter is selected, the parameter scores for the new parameter can be displayed in the entries in the parameter of interest section 540.

Sphere composite ranking section 550 can list all of the patents in the population and the target patent. Each entry in the list can provide the patent number of a patent in the patent population, the patent's assignee, and the patent's composite score. A button can be provided for scrolling through sphere composite ranking section 550 if the number of patents is greater than can fit on the screen at the same time. The highlighted entry 552 is the patent for which the composite score is currently shown in the composite score display 560.

In an embodiment, the system can be used to create a technology or industry index. For example, a semiconductor technology index can be created. The index can include a list of semiconductor patents included in the index, the parameter and composite scores of the included patents, and an average parameter and composite score of patents in the semiconductor technology sphere. The index can be used as a benchmark by which members of an industry gauge the value of patents within the same technology sphere. Other data can be provided as well, such as the number of unexpired patents that can be classified within the technology sphere (thus providing a measure of the crowdedness of the field) and the primary holders of such patents. In addition, industry, technological, and/or patent prosecution trends can be identified. The index can be publicized, offered as part of the system, and/or integrated in the system as one or more score categories.

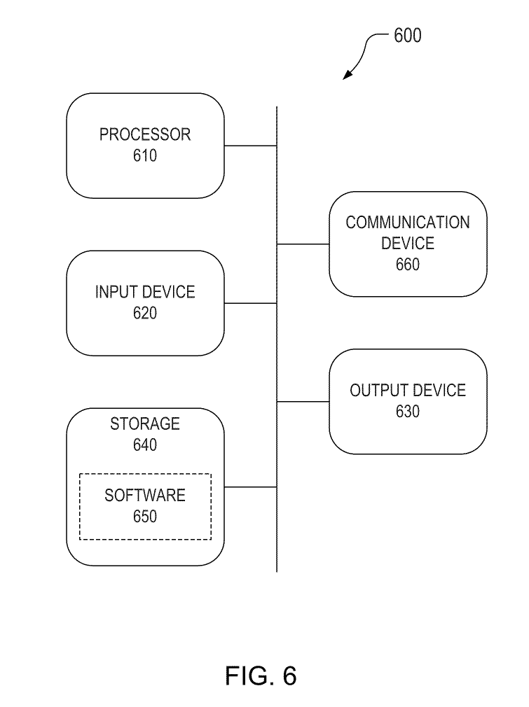

FIG. 6 shows a block diagram of an example of a computing device, which may generally correspond to client 200 and server 210. The form of computing device 600 may be widely varied. For example, computing device 600 can be a personal computer, workstation, server, handheld computing device, or any other suitable type of microprocessor-based device. Computing device 600 can include, for example, one or more components including processor 610, input device 620, output device 630, storage 640, and communication device 660. These components may be widely varied, and can be connected to each other in any suitable manner, such as via a physical bus, network line or wirelessly for example.

For example, input device 620 may include a keyboard, mouse, touch screen or monitor, voice-recognition device, or any other suitable device that provides input. Output device 630 may include, for example, a monitor or other display, printer, disk drive, speakers, or any other suitable device that provides output.

Storage 640 may include volatile and/or nonvolatile data storage, such as one or more electrical, magnetic or optical memories such as a RAM, cache, hard drive, CD-ROM drive, tape drive or removable storage disk for example. Communication device 660 may include, for example, a network interface card, modem or any other suitable device capable of transmitting and receiving signals over a network.

Network 205 may include any suitable interconnected communication system, such as a local area network (LAN) or wide area network (WAN) for example. Network 205 may implement any suitable communications protocol and may be secured by any suitable security protocol. The corresponding network links may include, for example, telephone lines, DSL, cable networks, T1 or T3 lines, wireless network connections, or any other suitable arrangement that implements the transmission and reception of network signals.

Software 650 can be stored in storage 640 and executed by processor 610, and may include, for example, programming that embodies the functionality described in the various embodiments of the present disclosure. The programming may take any suitable form. For example, in one embodiment, programming embodying the patent collection search functionality of search engine 220 can be based on an enterprise search platform, such as the Fast Enterprise Search Platform by Microsoft Corp. for example.

Software 650 can also be stored and/or transported within any computer-readable storage medium for use by or in connection with an instruction execution system, apparatus, or device, such as computing device 600 for example, that can fetch instructions associated with the software from the instruction execution system, apparatus, or device and execute the instructions. In the context of this document, a computer-readable storage medium can be any medium, such as storage 640 for example, that can contain or store programming for use by or in connection with an instruction execution system, apparatus, or device.

Software 650 can also be propagated within any transport medium for use by or in connection with an instruction execution system, apparatus, or device, such as computing device 600 for example, that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

What is claimed is:

1. A method for scoring a patent, comprising:
selecting a target patent;
selecting a score category, the score category specifying a plurality of parameters and a plurality of weights, wherein each parameter is associated with a respective weight of the plurality of weights;
selecting a plurality of comparison patents to be included in a patent population;
determining a value of each parameter in the target patent using a microprocessor;
determining an average value of each parameter in the patent population;
determining a standard deviation of each parameter in the patent population;
determining a parameter score for each parameter based on the value of the parameter in the target patent, the average value of the parameter in the patent population, and the standard deviation of the parameter in the patent population; and
determining a composite score of the target patent based on (i) multiplying each parameter score by the respective weight associated with the parameter corresponding to the parameter score to obtain a weighted parameter score for each parameter and (ii) adding together the weighted parameter scores.

2. The method of claim 1, wherein the score category is selected using a graphical user interface.

3. The method of claim 1, wherein the score category is automatically selected.

4. The method of claim 1, wherein the score category is created by a user and stored in association with a user profile.

5. The method of claim 1, wherein a graphical user interface displays the plurality of parameters and the plurality of weights specified by the selected score category.

6. The method of claim 5, wherein the plurality of weights can be modified using the graphical user interface.

7. The method of claim 5, wherein the graphical user interface displays additional parameters and corresponding weights initially set to zero.

8. The method of claim 7, further comprising determining a parameter score for each additional parameter.

9. The method of claim 8, further comprising modifying the weights corresponding to the additional parameters based on the parameter scores of the additional parameters.

10. The method of claim 7, wherein if a weight corresponding to an additional parameter is modified to be greater than zero, the additional parameter is processed along with the plurality of parameters so that the composite score is additionally based on a weighted parameter score of the target patent for the additional parameter.

11. The method of claim 10, wherein the processing of the additional parameter is performed substantially as the weight corresponding to the additional parameter is modified.

12. The method of claim 1, further comprising:
comparing the composite score of the target patent with one of the parameter scores of the target patent to determine whether a positive correlation exists between the scores; and
modifying the weight associated with the parameter corresponding to the parameter score to emphasize the correlation if determined that a correlation exists between the scores.

13. The method of claim 12, wherein the correlation is emphasized by increasing the weight if determined that there is a positive correlation between the scores.

14. The method of claim 1, wherein:
a plurality of target patents is selected,
a value of each parameter in each target patent is determined,
parameter scores of each of the plurality of target patents are determined for each of the parameters, and
a composite score is determined for each of the plurality of target patents.

15. The method of claim 14, further comprising:
determining a group composite score of the plurality of target patents based on (i) calculating a total score by adding together the composite scores of each of the target patents and (ii) dividing the total score by the number of target patents.

16. The method of claim 14, wherein the plurality of target patents and the plurality of comparison patents are identical.

17. The method of claim 14, wherein the plurality of target patents is selected by a search engine.

18. The method of claim 17, wherein the search engine selects the plurality of target patents by identifying patents associated with a specified law firm.

19. The method of claim 17, wherein the search engine selects the plurality of target patents by identifying patents classified within a specified class.

20. The method of claim 1, further comprising:
determining a value of each parameter in each of the plurality of comparison patents;
determining parameter scores of each of the plurality of comparison patents for each of the parameters; and
determining a composite score of each of the plurality of comparison patents.

21. The method of claim 20, further comprising determining a trend for one of the plurality of parameters based on the parameter scores of the target patent and the plurality of comparison patents.

22. The method of claim 1, wherein the score category specifies the plurality of comparison patents to be selected.

23. A method for scoring a patent, comprising:
selecting a target patent;
selecting a plurality of patents identified using a search engine based on characteristics of the target patent;
determining a value of a parameter in the target patent;
determining an average value of the parameter in a patent population comprising the plurality of patents;
determining a standard deviation of the parameter in the patent population;
determining a parameter score of the target patent based on the value of the parameter in the target patent, the average value of the parameter in the patent population, and the standard deviation of the parameter in the patent population; and
determining a composite score of the target patent based on the target patent's parameter score.

24. A method according to claim 23, wherein the search is performed by comparing a document vector corresponding to the target patent with document vectors corresponding to patents in the patent collection.

25. A method according to claim 23, wherein the parameter is specified by a user.

26. A method according to claim 23, wherein the patent population further comprises the target patent.

27. A method according to claim 23, further comprising:
(a) determining a parameter score of a patent in the patent population based on a value of the parameter in the patent, the average value of the parameter in the patent population, and the standard deviation of the parameter in the patent population;
(b) providing a composite score of the patent based on the patent's parameter score; and
performing steps (a) and (b) for each patent in the patent population without a parameter score.

28. A method for scoring a patent, comprising:
selecting a target patent;
accessing a patent population comprising patents indicated in a work file specified by a user;
determining a value of the parameter in the target patent;
determining an average value of the parameter in the patent population;
determining a standard deviation of the parameter in the patent population;
determining a parameter score of the target patent using a microprocessor based on the value of the parameter in the target patent, the average value of the parameter in the patent population, and the standard deviation of the parameter in the patent population; and
determining a composite score of the target patent based on the target patent's parameter score.

29. A system comprising:
a user interface configured to receive designation of a target patent;
a search engine configured to identify a plurality of patents by searching a patent collection based on the target patent; and
a processor configured to
determine a value of a parameter in the target patent,
determine an average value of the parameter in a patent population comprising the plurality of patents,
determine a standard deviation of the parameter in the patent population,
determine a parameter score of the target patent based on the value of the parameter in the target patent, the average value of the parameter in the patent population, and the standard deviation of the parameter in the patent population, and
determine a composite score of the target patent based on the target patent's parameter score.

30. A system according to claim 29, wherein the search engine performs the search by comparing a document vector corresponding to the target patent with document vectors corresponding to patents in the patent collection.

31. A system comprising:
a user interface configured to receive designation of a work file indicating a plurality of patents; and
a processor configured to
determine a value of a parameter in a target patent,
determine an average value of the parameter in a patent population comprising the plurality of patents,
determine a standard deviation of the parameter in the patent population,
determine a parameter score of the target patent based on the value of the parameter in the target patent, the average value of the parameter in the patent population, and the standard deviation of the parameter in the patent population, and
determine a composite score of the target patent based on the target patent's parameter score.

32. An apparatus for scoring a patent, comprising:
a computer processor; and
a computer-readable storage medium having computer-executable instructions for:
selecting a target patent;
selecting a score category, the score category specifying a plurality of parameters and a plurality of weights, wherein each parameter is associated with a respective weight of the plurality of weights;
selecting a plurality of comparison patents to be included in a patent population;
determining a value of each parameter in the target patent;
determining an average value of each parameter in the patent population;
determining a standard deviation of each parameter in the patent population;
determining a parameter score for each parameter based on the value of the parameter in the target patent, the average value of the parameter in the patent population, and the standard deviation of the parameter in the patent population; and
determining a composite score of the target patent based on (i) multiplying each parameter score by the respective weight associated with the parameter corresponding to the parameter score to obtain a weighted parameter score for each parameter and (ii) adding together the weighted parameter scores.

33. A computer-readable medium storing instructions to be executed by a computer, the stored instructions comprising:
selecting a target patent;
identifying a plurality of patents by searching a patent collection based on the target patent;
determining a value of a parameter in the target patent;
determining an average value of the parameter in a patent population comprising the plurality of patents;
determining a standard deviation of the parameter in the patent population;
determining a parameter score of the target patent based on the value of the parameter in the target patent, the average value of the parameter in the patent population, and the standard deviation of the parameter in the patent population; and
determining a composite score of the target patent based on the target patent's parameter score.

34. A computer-readable medium storing instructions to be executed by a computer, the stored instructions comprising:
selecting a target patent;
accessing a patent population comprising patents indicated in a work file specified by a user;
determining a value of the parameter in the target patent;
determining an average value of the parameter in the patent population;
determining a standard deviation of the parameter in the patent population;
determining a parameter score of the target patent based on the value of the parameter in the target patent, the average value of the parameter in the patent population, and the standard deviation of the parameter in the patent population; and
determining a composite score of the target patent based on the target patent's parameter score.

35. A computer-readable storage medium storing computer-executable instructions to be executed by a computer, the stored instructions comprising:
selecting a target patent;
selecting a score category, the score category specifying a plurality of parameters and a plurality of weights, wherein each parameter is associated with a respective weight of the plurality of weights;
selecting a plurality of comparison patents to be included in a patent population;
determining a value of each parameter in the target patent;
determining an average value of each parameter in the patent population;
determining a standard deviation of each parameter in the patent population;
determining a parameter score for each parameter based on the value of the parameter in the target patent, the average value of the parameter in the patent population, and the standard deviation of the parameter in the patent population; and
determining a composite score of the target patent based on (i) multiplying each parameter score by the respective weight associated with the parameter corresponding to the parameter score to obtain a weighted parameter score for each parameter and (ii) adding together the weighted parameter scores.

36. A system for scoring a patent, comprising:
means for selecting a target patent;
means for selecting a plurality of patents identified using a search engine based on characteristics of the target patent;
means for determining a value of a parameter in the target patent;
means for determining an average value of the parameter in a patent population comprising the plurality of patents;
means for determining a standard deviation of the parameter in the patent population;
means for determining a parameter score of the target patent based on the value of the parameter in the target patent, the average value of the parameter in the patent population, and the standard deviation of the parameter in the patent population; and
means for determining a composite score of the target patent based on the target patent's parameter score.

37. A system for scoring a patent, comprising:
means for selecting a target patent;
means for accessing a patent population comprising patents indicated in a work file specified by a user;
means for determining a value of the parameter in the target patent;
means for determining an average value of the parameter in the patent population;
means for determining a standard deviation of the parameter in the patent population;
means for determining a parameter score of the target patent based on the value of the parameter in the target patent, the average value of the parameter in the patent population, and the standard deviation of the parameter in the patent population; and
means for determining a composite score of the target patent based on the target patent's parameter score.

38. A system for scoring a patent, comprising:
means for selecting a target patent;
means for selecting a score category, the score category specifying a plurality of parameters and a plurality of weights, wherein each parameter is associated with a respective weight of the plurality of weights;
means for selecting a plurality of comparison patents to be included in a patent population;
means for determining a value of each parameter in the target patent;
means for determining an average value of each parameter in the patent population;
means for determining a standard deviation of each parameter in the patent population;
means for determining a parameter score for each parameter based on the value of the parameter in the target patent, the average value of the parameter in the patent population, and the standard deviation of the parameter in the patent population; and
means for determining a composite score of the target patent based on (i) multiplying each parameter score by the respective weight associated with the parameter corresponding to the parameter score to obtain a weighted parameter score for each parameter and (ii) adding together the weighted parameter scores.
